(19) United States
(12) Patent Application Publication
(10) Pub. No.: US 2017/0001287 A1
(43) Pub. Date: Jan. 5, 2017

(54) METHOD AND DEVICE FOR SECURING A THREADED ELEMENT SCREWED INTO A THREADED SEAT, METHOD FOR MOUNTING AT LEAST ONE BALANCING WEIGHT OF A TURBINE, AND A TURBINE

(71) Applicant: SIEMENS AKTIENGESELLSCHAFT, Munich (DE)

(72) Inventor: Stefan Bentele, Müheim an der Ruhr (DE)

(73) Assignee: Siemens Aktiengesellschaft, Munich (DE)

(21) Appl. No.: 15/115,346

(22) PCT Filed: Jan. 7, 2015
(86) PCT No.: PCT/EP2015/050137

§ 371 Date: Jul. 29, 2016

(30) Foreign Application Priority Data
Feb. 7, 2014 (EP) 14154247.2

(51) Int. Cl. B25B 13/48; F01D 5/02; F16B 39/02; B25B 15/00; B25B 13/06

(52) U.S. Cl. CPC B25B 13/481; B25B 15/008; B25B 13/06; F16B 39/025; F01D 5/027; F05D 2220/31; F05D 2230/60

(57) ABSTRACT

A method for securing a threaded element screwed into a threaded seat wherein the threaded element is at least partially plastically deformed by a deformation element of a tool such that the threaded element is subsequently arranged secured against rotation in the threaded seat. The tool is thereby placed axially in front of the threaded element in that a guide element of the tool is inserted axially in a drive mount of the threaded element, wherein the deformation element thus placed axially in front of the threaded element is accelerated in the direction of the threaded element, and wherein the deformation element shifts relatively with respect to the guide element inserted in the drive mount such that at least the first thread of the threaded element and/or the threaded seat facing the tool is deformed by the deformation element in order to secure the threaded element in the threaded seat.

### CROSS REFERENCE TO RELATED APPLICATIONS

This application is the U.S. National Stage of International Application No. PCT/EP2015/050137 filed Jan. 7, 2015, and claims the benefit thereof. The International Application claims the benefit of European Application No. EP14154247 filed Feb. 7, 2014. All of the applications are incorporated by reference herein in their entirety.

### FIELD OF INVENTION

The invention relates on one hand to a method for securing a threaded element that is screwed into a threaded seat, in which at least the threaded element screwed into the threaded seat is at least partially plastically deformed by means of deforming means of a tool such that it is then arranged in a rotationally secure manner in the threaded seat.

The invention relates on the other hand to a method for installing at least one balancing weight of a turbine, in particular of a steam turbine, in which the at least one balancing weight is immobilized by means of a threaded element configured as a mounting screw, wherein, during a final balancing process carried out under operational conditions, the threaded element is tightened with a defined torque in a threaded seat.

The invention further relates to a device for securing a threaded element that is screwed into a threaded seat, using a tool for plastically deforming at least the threaded element, wherein the tool has a supporting body.

The invention also relates to a turbine, in particular a steam turbine, having at least one rotor that rotates and holds turbine blades, and having balancing weights for balancing the rotating rotor, in which the balancing weights are immobilized by means of a mounting screw configured as a threaded element, and in which the threaded element is secured in its threaded seat using a captive retaining means.

### BACKGROUND OF INVENTION

It is known, from the prior art, to balance rotating turbine blades or a corresponding turbine rotor of a turbine using balancing weights such that a turbine shaft, equipped therewith, of the turbine can rotate with as little vibration as possible during operation and thus rotation of the turbine shaft can be affected as little as possible by the negative influence of imbalances caused by an arrangement of the turbine rotor and the turbine blades arranged thereon. Corresponding balancing is usually carried out in the factory during assembly of the turbine, in a balancing installation and using balancing weights. The balancing weights are generally placed in annular slots, provided for this purpose, on the turbine rotor and are each fixed in position in these annular slots using at least one mounting screw. In the factory, these mounting screws can be prevented from coming loose unintentionally, for example by peening in their respective threaded seat, such that the balancing weights as a whole are captively retained. After installation of balancing weights in a final balancing procedure in a power plant, on-site and under operational conditions, the balancing weights used can however be tightened only with a defined torque. Additionally securing mounting screws, provided for this purpose, against coming loose unintentionally, for example by peening in the threaded seat, is generally no longer possible, or is possible only with great difficulty and insufficiently, on account of poor accessibility. This poor accessibility is a result of the fact that the balancing weights are arranged at a distance of approximately 650 mm from an access point and can be reached only through an access bore with a diameter of approximately 80 mm or similar. For that reason, these balancing weights or their mounting screws are not additionally secured, resulting in the danger that the thus unsecured mounting screws can more easily come loose, and consequently that the balancing weights can leave their provided position. As a consequence, the turbine shaft rotates less cleanly.

In turn, this can lead to increased wear overall and to premature maintenance work and thus downtime of the turbine.

For example, U.S. Pat. No. 6,279,420 B1 discloses a balancing weight for rotating components in turbo machines, corresponding mounting tools and a mounting method for mounting the balancing weight. In this context, the balancing weight is inserted into a circumferential slot of a rotor, and is immobilized therein at an appropriate balancing position. To that end, a first rotating tool rotates the balancing weight through 90° about a vertical axis in the circumferential slot, and thus positions it. In order to secure the balancing weight in this balancing position, another tool, namely an additional indenting impact tool, is used on one hand to punctually plastically deform the edges of the circumferential slot by means of impact tips of the indenting impact tool, such that deformation regions resulting from this on the head side can be deflected into slits provided for that purpose in the balancing weight. On the other hand, a thread of a threaded seat machined into the balancing weight is additionally plastically deformed using a central impact attachment of the indenting impact tool.

In addition, EP 1 052 424 A2 discloses a device for balancing a turbine rotor about an axis of rotation, wherein an attachment element, namely a screw, can be indented with a balancing weight in order that the attachment element and the balancing weight secure one another.

U.S. Pat. No. 1,952,395 A describes a device for inserting screws, wherein the device comprises a swage by means of which the screw head can be deformed to behind an undercut of the through-hole or a rim of a through-bore partially as far as over the screw head of a screw screwed into a component.

Furthermore, U.S. Pat. No. 2,438,744 A discloses a tool for inserting bushings or inserts into a bore of a softer metal part. In that context, the bushing is screwed into a threaded section of the bore with the aid of the tool. Then, using a stamp of the tool, the bore and the bushing are deformed punctually such that the bushing sits irrotationally in the bore of the softer metal part and the tool can be unscrewed from the bushing.

### SUMMARY OF INVENTION

The invention has an object of overcoming at least the above-mentioned drawbacks.

The object of the invention is achieved with a method for securing a threaded element that is screwed into a threaded balancing weight seat of a turbine arrangement and that is configured as a mounting screw, in which at least the threaded element screwed into the threaded balancing weight seat is at least partially plastically deformed by means of deforming means of a tool such that it is then arranged in a rotationally secure manner in the threaded balancing weight seat, wherein the tool is placed axially in front of the threaded element, in that a guide element of the tool is plugged axially into a drive recess of the threaded element, wherein the deforming means placed axially in front of the threaded element are accelerated in the direction of the threaded element, and wherein the deforming means move relative to the guide element plugged into the drive recess such that at least the first thread turn, oriented toward the tool, of the threaded element and/or of the threaded balancing weight seat is deformed by the deforming means in order to secure the threaded element in the threaded balancing weight seat.

Advantageously, the tool provided for the deformation is positioned with respect to the threaded element by means of the guide element plugged into the drive recess of the threaded element such that especially the threaded seat can be plastically deformed more precisely by the deforming means, in spite of poor accessibility, from an otherwise critical distance, such that the threaded element is reliably secured against rotation. To that end, the deforming means can then be moved relative to the guide element.

Due to the effect that the present method makes it possible to achieve good deformation of the threaded seat and/or of the threaded element from a greater distance, even at a poorly accessible location, it is advantageous that the threaded element is screwed as a mounting screw into a balancing weight of a turbine arrangement prior to securing, in order to be able to immobilize the balancing weight in an operationally secure manner, for example in an annular slot of a turbine rotor.

Advantageously, the tool can in this context easily be guided through an access bore that is for example more than 500 mm long and only has a diameter of less than 100 mm, before the threaded element and/or advantageously the threaded seat is plastically deformed in a suitable manner by means of the tool.

In that respect, the present invention makes it possible to very effectively secure a threaded element, such as a mounting screw or the like, within a threaded seat lying deep in a turbine arrangement.

It is thus advantageous if, by means of the threaded element, a balancing weight of a turbine, in particular of a steam turbine, can be secured against unintentional movement away from a provided position.

In that respect, the object of the invention is also achieved with a method for installing at least one balancing weight of a turbine, in particular of a steam turbine, in which the at least one balancing weight is immobilized by means of a threaded element configured as a mounting screw, wherein, during a final balancing process carried out under operational conditions, the threaded element is tightened with a defined torque in a threaded balancing weight seat, wherein at least the threaded element screwed into the threaded balancing weight seat is at least partially plastically deformed by deforming means of a tool such that it is then arranged in a rotationally secure manner in the threaded balancing weight seat, wherein the tool is placed axially in front of the threaded element, in that a guide element of the tool is plugged axially into a drive recess of the threaded element, wherein the deforming means placed thus axially in front of the threaded element are accelerated in the direction of the threaded element, and wherein the deforming means move relative to the guide element plugged into the drive recess such that at least the first thread turn, oriented toward the tool, of the threaded element and/or of the threaded balancing weight seat is deformed by the deforming means in order to secure the threaded element in the threaded balancing weight seat.

In particular, the method according to the invention not only provides very good access to the mounting screws of the balancing weights and their threaded seats, access to which is generally poor and is often possible only through a deep access bore, but also makes it possible to plastically deform these with such precision that they can also subsequently be loosened without difficulty. All this is possible without incurring the risk for example of them shearing off through being subjected to excessive force.

To that end, the impact of the deforming means on the threaded element and/or on the threaded seat located in the balancing weight ideally plastically deforms only the first thread turn of the threaded element and/or advantageously of the threaded seat, in order to deform at least the threaded element or the mounting screw, which advantageously sits approximately 1 mm below the surface of the balancing weight. Advantageously, this plastically deforms in particular the balancing weight, since the threaded seat is machined therein.

Accordingly, advantageously at least the first thread turn created in the balancing weight is plastically deformed.

Expediently, the tool is guided through an access bore of a turbine arrangement as far as the threaded element, in order to plastically deform the threaded element and/or the threaded seat.

Moreover, the object of the invention is also achieved with a turbine balancing weight securing device for securing a threaded element that is screwed into a threaded balancing weight seat and that is configured as a mounting screw, using a tool for deforming at least the threaded element and for carrying out the above-explained method, wherein the tool has a supporting body on which there are arranged on one hand a guide element that can be plugged into the threaded element, and on the other hand deforming means for plastically deforming the threaded element and/or the threaded seat, and wherein the guide element is mounted on the supporting body such that it can be displaced relative to the deforming means.

The thus configured turbine balancing weight securing device is particularly well-suited to carrying out one of the methods described here, and their advantageous refinements.

Hence, the present turbine balancing weight securing device can also be used particularly well for the final assembly of at least one balancing element of a turbine, in particular of a steam turbine.

A particularly advantageous method variant provides that the guide element is plugged into a drive recess of the threaded element such that the deforming means is oriented centrally with respect to the threaded element. This allows the plastic deformation to be carried out with particular precision.

In this context, the guide element of the tool is advantageously matched precisely to the threaded element or mounting screw that is used. If the threaded element or the mounting screw is for example a slot-head or cross-head screw with a drive recess of corresponding configuration, it is advantageous if the guide element comprises a compatible flat-blade or cross-head bit, such that it can be plugged into the respective drive recess.

In general, a mounting screw is realized in the form of a hexagon socket screw or a grub screw with a hexagon socket drive recess, in order to be able to be screwed into a balancing weight, for example without standing proud. Accordingly, it is advantageous if the guide element has a male hexagon driver bit.

In the present case, deformation can be made markedly more precise if the guide element and the deforming means can be moved in translation with respect to one another. It is therefore advantageous if the guide element is mounted such that it can slide linearly within the supporting body along the central axis of the tool. Thus, the guide element can move into the supporting body when the deforming means are placed or struck on the threaded element or the mounting screw or advantageously on the balancing weight.

In order to be able to expediently plug the guide element into the drive recess, it is advantageous if the guide element is arranged, on the head side of the tool, such that it projects at least temporarily beyond the deforming means.

If the guide element is mounted spring-preloaded within the supporting body, it can be pushed back out of this supporting body after it has been temporarily moved into the supporting body for the purpose of a plastic deformation process, this being simple in terms of construction.

The guide element can be more quickly plugged into the drive recess of the threaded element or of the mounting screw if the guide element is arranged such that it cannot rotate about the central axis of the tool.

A number of constructions can be employed to effect rotation prevention for this purpose. This can be realized particularly simply in terms of construction if an anti-rotation bolt is arranged on the guide element, which bolt is guided radially so as to project into a guide slot, of the supporting body, that extends in the direction of the central longitudinal axis of the tool.

In order, in particular, to be able to deform the threaded seat and/or the threaded element or the mounting screw in a suitable fashion, the deforming means can be of different form.

It is particularly advantageous if the deforming means comprise a multiplicity of conical deforming tips.

Advantageously, multiple such deforming tips are arranged concentrically around the guide element.

Of course, the deforming means must be made hard enough for long-term service. It is therefore advantageous if the deforming means comprise hardened deforming tips.

The multiplicity of deforming tips can be provided, in a manner which is simple in terms of construction, by means of a hardened annular crown element, which per se forms deforming tips.

The tool itself can then be used superbly if it can be actuated through a deeper or structurally longer access bore. For this reason alone, it is advantageous if the tool has a recess for an impact arm, which recess is arranged at one end of the supporting body, oriented away from the guide element.

The impact arm allows an impact force—imparted manually or by means of a pneumatically controllable single-impact hammer—to be transferred easily through the access bore to the tool.

Use of the device can be more flexible if it is adjustable in length. The length can for example be set by means of the exchangeable impact arm. One option is for the arm itself to be adjustable in length. Alternatively, depending on the conditions of use, impact arms of different lengths can optionally be attached to the tool.

In order to be able to easily release the threaded element or the mounting screw from its respective threaded seat, it is advantageous if the threaded element and/or the threaded seat is merely deformed such that it can be released again from the threaded seat.

Release in this manner works sufficiently well if less than 25%, and advantageously less than 20%, of the thread of the threaded element and/or of the threaded seat is deformed plastically. Hitherto, during balancing in the balancing installation, the balancing weights were secured by destroying more than 30% of the thread of the mounting screw, as non-releasable captive retention. Alternatively, such retention was omitted during balancing in the power plant.

The object of the invention is also achieved with a turbine, in particular a steam turbine, having at least one rotor that rotates and holds turbine blades, and having balancing weights for balancing the rotating rotor, in which the balancing weights are immobilized by means of a mounting screw configured as a threaded element, and in which the threaded element is secured in its threaded balancing weight seat using a captive retaining means, wherein the captive retaining means is created by a plastic deformation of the threaded element and/or of the threaded balancing weight seat, such that only a first turn of the thread of the threaded element and/or of the threaded balancing weight seat is plastically deformed, such that the threaded element can once again be unscrewed from its threaded balancing weight seat in order to be able to move or remove the balancing weight.

Captive retention created in this manner makes it possible to significantly reduce the probability of the turbine breaking down due to a balancing weight coming loose unintentionally.

It is particularly advantageous that, in this context, the threaded element or the mounting screw and/or the threaded balancing weight seat is plastically deformed only to the extent that it/they can be released again if necessary. For that reason, advantageously only a single thread turn of the threaded element or of the mounting screw and/or of the threaded balancing weight seat is plastically deformed. And, in particular, this can be ensured superbly with the device described here.

Good releasability through a deeper or structurally longer access bore can, to that extent, be ensured if less than 25%, and advantageously less than 20%, of the thread of the threaded element and/or of the threaded balancing weight seat is destroyed by the plastic deformation.

There follows an explanation of a preferred embodiment of a device according to the invention for mounting a balancing weight on a steam turbine and an arrangement of the balancing weight in an annular slot of a steam turbine rotor of the steam turbine, with reference to the appended schematic drawings.

### BRIEF DESCRIPTION OF THE DRAWINGS

In the drawings:

FIG. 1 shows, schematically, a view of a device, in particular for the final installation of a balancing weight on a steam turbine, having a tool for plastically deforming a thread of a threaded seat of a mounting screw of the balancing weight,

FIG. 2 shows, schematically, a positional view of the balancing weight in its final position in an annular slot of a steam turbine rotor, and

FIG. 3 shows, schematically, a plan view of the balancing weight of FIG. 2 in its final position in the annular slot of the steam turbine rotor.

### DETAILED DESCRIPTION OF INVENTION

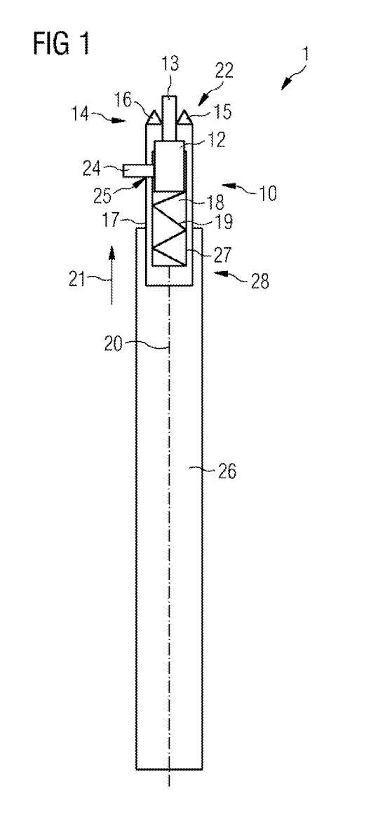

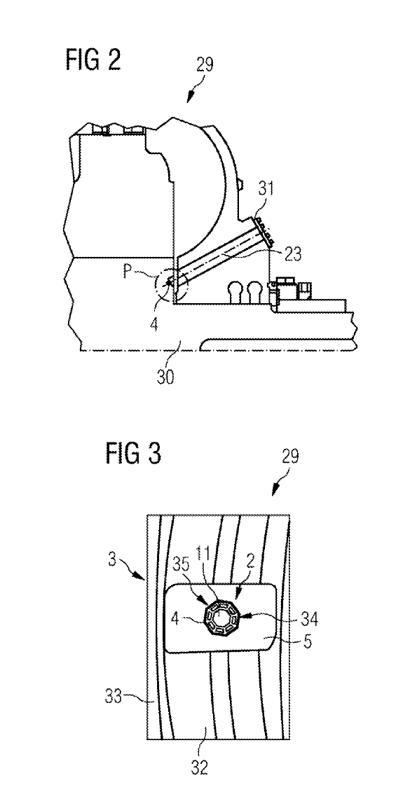

The device 1 shown in FIG. 1 is configured in this exemplary embodiment such that it is provided for securing a threaded element 3, here in the form of a mounting screw 4 of a balancing weight 5, which is screwed into a threaded seat 2 (see FIGS. 2 and 3).

To that end, the device 1 is equipped with a tool 10 by means of which at least the threaded seat 2 introduced into the balancing weight 5 and expediently also the mounting screw 4 can be plastically deformed. Thus, not only advantageously the balancing weight 5 but also the mounting screw 4 is plastically deformed with the device 1 for the purpose of creating captive retention for the mounting screw 4.

The tool 10 comprises on one hand a guide element 12 that can be plugged into the threaded element 3, more specifically into a drive recess 11 (see FIG. 2) of the threaded element 3, such that the tool 10 can be placed centrally in front of the threaded element 3 in an operationally secure manner, before especially the threaded seat 2 is plastically deformed by the tool 10. Since the threaded element 3 shown is a mounting screw 4 in the form of a hexagon-socket grub screw, the guide element 12 is equipped, at its end, with a corresponding male hexagon driver bit 13.

On the other hand, the tool 10 comprises deforming means 14 for plastically deforming at least the threaded seat 2. In this exemplary embodiment, the deforming means 14 are embodied as a hardened crown ring 15 that provides a multiplicity of hardened deforming tips 16 (numbered only by way of example) that are arranged concentrically around the male hexagon driver bit 13.

The tool 10 has an elongate metallic supporting body 17 that supports both the guide element 12 and the deforming means 14 such that the guide element 12 is mounted on the tool 10 such that it can be displaced relative to the deforming means 14.

In this context, the supporting body 17 forms a cavity 18 in which the guide element 12 is mounted, by means of a spring element 19, such that it can slide linearly within the supporting body 17 along the central longitudinal axis 20 of the tool 10.

In that respect, the guide element 12 is permanently pressed, with a certain preload, outward and in the direction 21 of the deforming means 14, such that, in the resting state, the guide element 12 is arranged, on the head side 22 of the tool 10, such that it projects beyond the deforming means 14. Thus, the tool 10 with its male hexagon driver bit 13 can be relatively easily threaded even through a relatively long access bore 23 of approximately 600 mm (see FIG. 2) into the drive recess 11 of the threaded element 3, deep in the access bore 23, and thus plugged in, whereby the deforming means 14 of the tool 10 can be placed with great precision in front of the threaded seat 2 and the threaded element 3 and in particular concentrically around the drive recess 11 of the threaded element 3. This makes it possible to plastically deform the threaded seat 2 in the transition region to the threaded element 3 and possibly also the edge region of the threaded element 3 such that the threaded element 3 is secured in the threaded seat 2 such that it cannot rotate but can be released using a rotary tool (not shown). In this context, only the first turn of the thread of the threaded seat 2 and, depending on the configuration of the threaded element 3, also only one thread turn of the threaded element 3, is/are plastically deformed such that the threaded element 3 can be removed from its threaded seat 2.

To make it simple to thread or plug the guide element 12 into the drive recess 11 of the threaded element 3, the guide element 12 is arranged such that it cannot rotate about the central longitudinal axis 20 of the tool 10. To that end, the guide element 12 has a rotation-preventing bolt 24 which projects radially from the central longitudinal axis 20 and projects into a guide slot 25, of the supporting body 17, that extends in the direction of the central longitudinal axis 20 of the tool 10, and is thus guided axially along the central longitudinal axis 20.

The length of the device 1 can be set simply, in terms of construction, using an exchangeable impact arm 26 which can be pushed on, at the back of the tool 10, at a corresponding recess 27 formed on the supporting body 17. The recess 27 is thus arranged at an end 28 of the supporting body 17 oriented away from the guide element 12, that is to say at the back.

The approximately 600 mm-long access bore 23 on a steam turbine arrangement 29 of a steam turbine 30 is clearly visible in the illustration in FIG. 2. The access bore 23 leads to the position P where the balancing element 5, shown by way of example, is placed within the steam turbine arrangement 29. The entrance to the access bore 23 can be closed with a closure element 31 after completion of final installation of the balancing weight 5.

As shown in the illustration of the steam turbine arrangement 29 in FIG. 3, the balancing weight 5 is already secured, by the mounting screw 4, in an annular slot 32 of a steam turbine rotor 33 of the steam turbine 30. In this context, the mounting screw 4 is peened in the threaded seat 2 of the balancing weight 5 by the device 1 described in FIG. 1. Corresponding plastic deformation of the threaded seat 2 of the balancing weight 5 on one hand, and possibly of the mounting screw 4 on the other hand, creates captive retention such that the mounting screw 4 cannot unintentionally come loose in the threaded seat 2. Clearly visible are the peening indentations 34, caused by the plastic deformation, on the outer rim 35 of the mounting screw 4 and of the balancing weight 5.

Although the invention has been described and illustrated in more detail by way of the preferred exemplary embodiment, the invention is not restricted by this disclosed exemplary embodiment and other variations can be derived herefrom by a person skilled in the art without departing from the scope of protection of the invention.

1. A method for securing a threaded element that is screwed into a threaded balancing weight seat of a turbine arrangement and that is configured as a mounting screw, the method comprising:
at least partially plastically deforming at least the threaded element screwed into the threaded balancing weight seat by means of deforming means of a tool such that it is then arranged in a rotationally secure manner in the threaded balancing weight seat,
placing the tool axially in front of the threaded element, in that a guide element of the tool is plugged axially into a drive recess of the threaded element,
accelerating the deforming means placed axially in front of the threaded element in the direction of the threaded element, and
moving the deforming means move relative to the guide element plugged into the drive recess such that at least the first thread turn, oriented toward the tool, of the threaded element and/or of the threaded balancing weight seat is deformed by the deforming means in order to secure the threaded element in the threaded balancing weight seat.

2. A method for installing at least one balancing weight of a turbine or a steam turbine, the method comprising:
immobilizing the at least one balancing weight by means of a threaded element configured as a mounting screw,
during a final balancing process carried out under operational conditions, tightening the threaded element with a defined torque in a threaded balancing weight seat,
at least partially plastically deforming at least the threaded element screwed into the threaded balancing weight seat by deforming means of a tool such that it is then arranged in a rotationally secure manner in the threaded balancing weight seat,
placing the tool axially in front of the threaded element, in that a guide element of the tool is plugged axially into a drive recess of the threaded element, and
accelerating the deforming means placed thus axially in front of the threaded element in the direction of the threaded element,
moving the deforming means relative to the guide element plugged into the drive recess such that at least the first thread turn, oriented toward the tool, of the threaded element and/or of the threaded balancing weight seat is deformed by the deforming means in order to secure the threaded element in the threaded balancing weight seat.

3. The method as claimed in claim 1,
wherein the guide element is plugged into a drive recess of the threaded element such that the deforming means is oriented centrally with respect to the threaded element.

4. The method as claimed in claim 1,
wherein the tool is guided through an access bore of a turbine arrangement as far as the threaded element, in order to plastically deform the threaded element and/or the threaded seat.

5. The method as claimed in claim 1,
wherein less than 25%, of the thread of the threaded element and/or of the threaded balancing weight seat is deformed plastically.

6. A turbine balancing weight securing device for securing a threaded element that is screwed into a threaded balancing weight seat and that is configured as a mounting screw, using a tool for plastically deforming at least the threaded element and for carrying out a method as claimed in claim 1, wherein the tool comprises:
a supporting body on which there are arranged on one hand a guide element that can be plugged into the threaded element configured as a mounting screw, and on the other hand deforming means for plastically deforming the threaded element and/or the threaded balancing weight seat, and
wherein the guide element is mounted on the supporting body such that it can be displaced relative to the deforming means.

7. The turbine balancing weight securing device as claimed in claim 6,
wherein the guide element is mounted such that it can move linearly within the supporting body along the central longitudinal axis of the tool.

8. The device as claimed in claim 6,
wherein the guide element is arranged, on the head side of the tool, such that it projects at least temporarily beyond the deforming means.

9. The device as claimed in claim 6,
wherein the guide element is mounted spring-preloaded within the supporting body.

10. The device as claimed in claim 6,
wherein the guide element is arranged such that it cannot rotate about the central longitudinal axis of the tool.

11. The device as claimed in claim 6,
wherein an anti-rotation bolt is arranged on the guide element, which bolt is guided radially so as to project into a guide slot, of the supporting body, that extends in the direction of the central longitudinal axis of the tool.

12. The device as claimed in claim 6,
wherein the guide element has a male hexagon driver bit.

13. The device as claimed in claim 6,
wherein the deforming means comprise a multiplicity of conical deforming tips which are arranged concentrically around the guide element.

14. The device as claimed in claim 6,
wherein the tool has a recess for an impact arm, which recess is arranged at one end of the supporting body, oriented away from the guide element.

15. The device as claimed in claim 6,
wherein the device is adjustable in length in order to be adapted to access bores of different lengths.

16. A turbine or a steam turbine, having
at least one rotor that rotates and holds turbine blades, and having balancing weights for balancing the rotating rotor,
wherein the balancing weights are immobilized by means of a mounting screw configured as a threaded element, and
wherein the threaded element is secured in its threaded balancing weight seat using a captive retainer, wherein the captive retainer is created by a plastic deformation of the threaded element and/or of the threaded balancing weight seat,
wherein only a first turn of the thread of the threaded element and/or of the threaded balancing weight seat is plastically deformed, such that the threaded element can once again be unscrewed from its threaded balancing weight seat in order to be able to move or remove the balancing weight.

17. The turbine as claimed in claim 16,
wherein less than 25%, of the thread of the threaded element and/or of the threaded balancing weight seat is destroyed by the plastic deformation.

18. The turbine as claimed in claim 16,
wherein less than 20% of the thread of the threaded element and/or of the threaded balancing weight seat is destroyed by the plastic deformation.

19. The method as claimed in claim 1,
wherein less than 20% of the thread of the threaded element and/or of the threaded balancing weight seat is destroyed by the plastic deformation.
